(19) United States
(12) Patent Application Publication
(10) Pub. No.: US 2020/0122448 A1
(43) Pub. Date: Apr. 23, 2020

(54) FILMS HAVING A SCRATCH-RESISTANT COATING AS A COVER LAYER AND LAYERED COMPOSITES COMPRISING SUCH FILMS

(71) Applicant: Covestro Deutschland AG, Leverkusen (DE)

(72) Inventors: Joachim PETZOLDT, Monheim (DE); Georgios TZIOVARAS, Neuss (DE); Kay LAUTWEIN, Köln (DE); Christoph KÖHLER, Duisburg (DE)

(21) Appl. No.: 16/615,318

(22) PCT Filed: May 22, 2018
(86) PCT No.: PCT/EP2018/063318

§ 371 Date: Nov. 20, 2019

(30) Foreign Application Priority Data
May 22, 2017 (EP) 17172150.9
May 26, 2017 (LU) LU100262

(51) Int. Cl. B32B 37/12; C09D 4/00; B32B 27/08; B32B 27/36

(52) U.S. Cl. CPC B32B 37/12; C09D 4/00; B32B 27/08; C08J 2433/00; B32B 2425/00; C08J 2367/02; C08J 2369/00; B32B 27/365

(57) ABSTRACT

The invention relates to heteroaromatic compounds, particularly for use in electronic devices. The invention further relates to a method for producing the compounds according to the invention and to electronic devices containing same.

The invention relates to thermoplastic films having a scratch-resistant coating as top layer, a method for producing same, security documents and/or valuable documents comprising at least one thermoplastic film having scratch-resistant coating as top layer on at least one outer side and also a method for producing same and also the use of a coating material composition for the production of coated plastics films.

Security documents and/or valuable documents, in particular identification documents such as for example personalized ID cards, are in general produced by laminating a plurality of different layers that assume various functions in the card, usually in the form of individual films, to form a card. This often involves additionally embossing structures with dimensions in the μm range as security features into the outer surface during the lamination process.

However, the thermoplastic materials that are preferably used for such documents normally have relatively soft surfaces that are susceptible to scratches. This is deleterious to readability over such a document's lifetime of up to ten years. In addition, security features may be destroyed.

A further typical requirement placed on personalized ID cards is bendability and fracture resistance. Despite frequently repeated flexural stress, the card itself—but also incorporated components such as electronic chips or RFID antennae—should not be impaired in terms of the function thereof.

Card readers in particular often lead to scratches on the card surface which reduce the bendability and fracture resistance of the card and hence shorten the lifetime of the card.

In order to guarantee the functionality of the cards over the lifetime both mechanically and with respect to readability, many manufacturers of personalized ID cards attempt to provide the outer sides of the cards with a scratch-resistant protective layer which is additionally intended to exhibit good chemical resistance.

Conventional scratch-resistant coating materials based on acrylates, as are used for electronics housings and lenses/displays, have outstanding scratch resistances and chemical resistances by dint of their high crosslinking density. The disadvantage of such systems lies, however, in an embrittlement that accompanies the crosslinking density. This has the effect that the card is impaired overall in terms of its fracture resistance due to notching (fracturing of the coating).

A further disadvantage is that the embossability of such highly crosslinked polymers is reduced. The highly crosslinked polymer can no longer be sufficiently deformed in order to adopt relatively fine structures of the master with sufficient reproduction sharpness.

EP-A 2460668 discloses security documents and/or valuable documents comprising a scratch-resistant coating on at least one outer side and also correspondingly coated thermoplastic films. The scratch-resistant coating comprises a radiation-curable coating material composition which, though having sufficient scratch-resistance, exhibits disadvantages in embossability and in flexibility when subjected to severe stress during use.

WO-A 2012/019583 discloses a method for coating a film with a dual cure coating material, the films obtainable by this method and also security documents and/or valuable documents comprising such films. Although the dual cure coating compositions disclosed in WO-A 2012/019583 satisfy the criterion of sufficient scratch-resistance, they do exhibit clear disadvantages in terms of resistance to various chemicals.

Accordingly, the need remained to provide films, in particular for security documents and/or valuable documents, very particularly identification documents such as ID cards, which display exceptional scratch-resistance that withstands the relatively high lamination temperatures during the production of the documents, enables embossing with structures on the micrometer scale and satisfies the bending strength and fracture resistance requirements of such documents even when subjected to severe stress during use, without significantly forfeiting scratch-resistance or chemical resistance at the same time.

The object on which the present invention was based was accordingly that of providing a film that has such a scratch-resistant coating and satisfies the above requirements, and also a security document and/or valuable document correspondingly equipped with same, and of finding a method for producing such a film and also a method for producing such security documents and/or valuable documents.

This object was surprisingly achieved by a film comprising a thermoplastic polymer and a coating, wherein the coating is obtainable from a coating material composition containing a urethane (meth)acrylate comprising isocyanate groups and (meth)acryloyl groups and an acrylated acrylate.

The present invention thus provides a film comprising a thermoplastic film and a coating, wherein the coating has been produced from a coating material composition containing
a) urethane (meth)acrylate which has (meth)acryloyl groups and an isocyanate functionality of ≥1.75 to ≤2.3, preferably of ≥1.85 to ≤2.2, very particularly preferably of ≥1.9 to ≤2.1,
b) acrylated acrylate which still has free isocyanate-reactive groups,
c) optionally additives and/or solvents.

In the context of this invention, “(meth)acrylate” and “(meth)acryloyl” refers to corresponding acrylate or methacrylate functions or to a mixture of both.

The NCO contents of the urethane (meth)acrylates were determined by titrimetric means according to DIN EN ISO 11909:2007-05. The average molecular weights were determined by gel permeation chromatography according to DIN 55672-1:2016-03 using polystyrene as standard. The isocyanate functionality can be calculated from these values, this functionality being an average value.

Regarding the thermoplastic film, this preferably concerns polymers of ethylenically unsaturated monomers and/or polycondensates of bifunctional reactive compounds and/or polyaddition products of bifunctional reactive compounds. For certain applications, for example in the field of identification documents, it may be advantageous and hence preferred to use a transparent thermoplastic. Such a thermoplastic film may be a single-layer or multilayer thermoplastic film, preferably a single-layer thermoplastic film. In the case of a multilayer thermoplastic film as substrate, this can be a thermoplastic film produced by means of coextrusion, extrusion lamination or lamination, preferably by means of coextrusion.

Particularly suitable thermoplastics are one or more polycarbonate(s) or copolycarbonate(s) based on diphenols, poly- or copoly(meth)acrylate(s) such as, by way of example and preferably, polymethyl methacrylate or poly(meth)acrylate (PMMA), polymer(s) or copolymer(s) with styrene such as, by way of example and preferably, polystyrene (PS), acrylonitrile-butadiene-styrene (ABS), or polystyrene-acrylonitrile (SAN), thermoplastic polyurethane(s) and also polyolefin(s) such as, by way of example and preferably, polypropylene types or polyolefins based on cyclic olefins (e.g TOPAS®, Hoechst), poly- or copolycondensate(s) of terephthalic acid such as, by way of example and preferably, poly- or copolyethylene terephthalate (PET or CoPET), glycol-modified PET (PETG), glycol-modified poly- or copolycyclohexanedimethylene terephthalate (PCTG) or poly- or copolybutylene terephthalate (PBT or CoPBT), polyamide (PA), poly- or copolycondensate(s) of naphthalenedicarboxylic acid such as, by way of example and preferably, polyethylene glycol naphthalate (PEN), poly- or copolycondensate(s) of at least one cycloalkyldicarboxylic acid such as, by way of example and preferably, polycyclohexanedimethanolcyclohexanedicarboxylic acid (PCCD), polysulfones (PSU), mixtures of the aforementioned or blends thereof, preferably one or more polycarbonates or copolycarbonates based on diphenols, poly- or copoly(meth)acrylates, poly- or copolycondensates of terephthalic acid or blends thereof.

Particularly preferred thermoplastics are one or more polycarbonate(s) or copolycarbonate(s) based on diphenols or blends comprising at least one polycarbonate or copolycarbonate. Very particular preference is given to blends comprising at least one polycarbonate or copolycarbonate and at least one poly- or copolycondensate of terephthalic acid, of naphthalenedicarboxylic acid or of a cycloalkyldicarboxylic acid, preferably of cyclohexanedicarboxylic acid. Very particular preference is given to polycarbonates or copolycarbonates, especially having average molecular weights Mw of 500 to 100 000, preferably of 10 000 to 80 000, particularly preferably of 15 000 to 40 000, or blends thereof with at least one poly- or copolycondensate of terephthalic acid having average molecular weights Mw of 10 000 to 200 000, preferably of 21 000 to 120 000.

Suitable poly- or copolycondensates of terephthalic acid in preferred embodiments of the invention are polyalkylene terephthalates. Examples of suitable polyalkylene terephthalates are reaction products of aromatic dicarboxylic acids or the reactive derivatives thereof (e.g. dimethyl esters or anhydrides) and aliphatic, cycloaliphatic or araliphatic diols, and mixtures of these reaction products.

Preferred polyalkylene terephthalates may be prepared from terephthalic acid (or reactive derivatives thereof) and aliphatic or cycloaliphatic diols having 2 to 10 carbon atoms by known methods (Kunststoff-Handbuch [Plastics Handbook], vol. VIII, p. 695 ff., Carl-Hanser-Verlag, Munich 1973).

Preferred polyalkylene terephthalates contain at least 80 mol %, preferably 90 mol % of terephthalic acid radicals, based on the dicarboxylic acid component, and at least 80 mol %, preferably at least 90 mol % of ethylene glycol and/or butane-1,4-diol and/or cyclohexane-1,4-dimethanol radicals, based on the diol component.

The preferred polyalkylene terephthalates may contain, in addition to terephthalic acid radicals, up to 20 mol % of radicals of other aromatic dicarboxylic acids having 8 to 14 carbon atoms or of aliphatic dicarboxylic acids having 4 to 12 carbon atoms, such as radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyalkylene terephthalates may contain, in addition to ethylene and/or butane-1,4-diol glycol radicals, up to 80 mol % of other aliphatic diols having 3 to 12 carbon atoms or of cycloaliphatic diols having 6 to 21 carbon atoms, for example radicals of propane-1,3-diol, 2-ethylpropane-1,3-diol, neopentyl glycol, pentane-1,5-diol, hexane-1,6-diol, cyclohexane-1,4-dimethanol, 3-methylpentane-2,4-diol, 2-methylpentane-2,4-diol, 2,2,4-trimethylpentane-1,3-diol and 2-ethylhexane-1,6-diol, 2,2-diethylpropane-1,3-diol, hexane-2,5-diol, 1,4-di([beta]-hydroxyethoxy)benzene, 2,2-bis(4-hydroxycyclohexyl)propane, 2,4-dihydroxy-1,1,3,3-tetramethylcyclobutane, 2,2-bis(3-[beta]-hydroxyethoxyphenyl)propane and 2,2-bis(4-hydroxypropoxyphenyl)propane (cf. DE-OS 24 07 674, 24 07 776, 27 15 932).

The polyalkylene terephthalates may be branched by incorporation of relatively small amounts of tri- or tetrahydric alcohols or tri- or tetrabasic carboxylic acids, as described for example in DE-OS 19 00 270 and U.S. Pat. No. 3,692,744. Examples of preferred branching agents are trimesic acid, trimellitic acid, trimethylolethane and trimethylolpropane, and pentaerythritol.

Preferably, not more than 1 mol % of the branching agent is used, based on the acid component.

Particular preference is given to polyalkylene terephthalates which have been prepared solely from terephthalic acid and the reactive derivatives thereof (e.g. the dialkyl esters thereof) and ethylene glycol and/or butane-1,4-diol and/or cyclohexane-1,4-dimethanol radicals, and to mixtures of these polyalkylene terephthalates.

Preferred polyalkylene terephthalates are also copolyesters prepared from at least two of the abovementioned acid components and/or from at least two of the abovementioned alcohol components; particularly preferred copolyesters are poly(ethylene glycol/butane-1,4-diol) terephthalates.

The polyalkylene terephthalates used with preference as component preferably have an intrinsic viscosity of about 0.4 to 1.5 dl/g, preferably 0.5 to 1.3 dl/g, measured in each case in phenol/o-dichlorobenzene (1:1 parts by weight) at 25° C.

In particularly preferred embodiments of the invention, the blend of at least one polycarbonate or copolycarbonate with at least one poly- or copolycondensate of terephthalic acid is a blend of at least one polycarbonate or copolycarbonate with poly- or copolybutylene terephthalate or glycol-modified poly- or copolycyclohexanedimethylene terephthalate. Such a blend of polycarbonate or copolycarbonate with poly- or copolybutylene terephthalate or glycol-modified poly- or copolycyclohexanedimethylene terephthalate may preferably be one having 1% to 90% by weight of polycarbonate or copolycarbonate and 99% to 10% by weight of poly- or copolybutylene terephthalate or glycol-modified poly- or copolycyclohexanedimethylene terephthalate, preferably having 1% to 90% by weight of polycarbonate and 99% to 10% by weight of polybutylene terephthalate or glycol-modified polycyclohexanedimethylene terephthalate, where the proportions add up to 100% by weight. Particularly preferably, such a blend of polycarbonate or copolycarbonate with poly- or copolybutylene terephthalate or glycol-modified poly- or copolycyclohexanedimethylene terephthalate may be one having 20% to 85% by weight of polycarbonate or copolycarbonate and 80% to 15% by weight of poly- or copolybutylene terephthalate or glycol-modified poly- or copolycyclohexanedimethylene terephthalate, preferably having 20% to 85% by weight of polycarbonate and 80% to 15% by weight of polybutylene terephthalate or glycol-modified polycyclohexanedimethylene terephthalate, where the proportions add up to 100% by weight. Very particularly preferably, such a blend of polycarbonate or copolycarbonate with poly- or copolybutylene terephthalate or glycol-modified poly- or copolycyclohexanedimethylene terephthalate may be one having 35% to 80% by weight of polycarbonate or copolycarbonate and 65% to 20% by weight of poly- or copolybutylene terephthalate or glycol-modified poly- or copolycyclohexanedimethylene terephthalate, preferably having 35% to 80% by weight of polycarbonate and 65% to 20% by weight of polybutylene terephthalate or glycol-modified polycyclohexanedimethylene terephthalate, where the proportions add up to 100% by weight. In very particularly preferred embodiments, these may be blends of polycarbonate and glycol-modified polycyclohexanedimethylene terephthalate in the compositions mentioned above.

Suitable polycarbonates or copolycarbonates in preferred embodiments are particularly aromatic polycarbonates or copolycarbonates.

The polycarbonates or copolycarbonates may be linear or branched in known fashion.

These polycarbonates may be prepared in known fashion from diphenols, carbonic acid derivatives, optionally chain terminators and optionally branching agents. Particulars pertaining to the preparation of polycarbonates are disclosed in many patent documents spanning approximately the last 40 years. Reference may be made here merely by way of example to Schnell, “Chemistry and Physics of Polycarbonates”, Polymer Reviews, volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, volume 11, second edition, 1988, pages 648-718 and finally to Drs. U. Grigo, K. Kirchner and P. R. Müller, “Polycarbonate” [Polycarbonates] in Becker/Braun, Kunststoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117-299.

Suitable diphenols may, for example, be dihydroxyaryl compounds of the general formula (I),

HO—Z—OH (I)

in which Z is an aromatic radical which has 6 to 34 carbon atoms and may contain one or more optionally substituted aromatic rings and aliphatic or cycloaliphatic radicals or alkylaryls or heteroatoms as bridging elements.

Examples of suitable dihydroxyaryl compounds are: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl)ethers, bis(hydroxyphenyl)ketones, bis(hydroxyphenyl)sulfides, bis(hydroxyphenyl)sulfones, bis(hydroxyphenyl)sulfoxides, 1,1′-bis(hydroxyphenyl)diisopropylbenzenes and the ring-alkylated and ring-halogenated compounds thereof.

These and further suitable other dihydroxyaryl compounds are described, for example, in DE-A 3 832 396, FR-A 1 561 518, in H. Schnell, Chemistry and Physics of Polycarbonates, Interscience Publishers, New York 1964, p. 28 ff.; p. 102 ff., and in D. G. Legrand, J. T. Bendler, Handbook of Polycarbonate Science and Technology, Marcel Dekker New York 2000, p. 72 ff.

Preferred dihydroxyaryl compounds are, for example, resorcinol, 4,4′-dihydroxydiphenyl, bis(4-hydroxyphenyl)methane, bis(3,5-dimethyl-4-hydroxyphenyl)methane, bis(4-hydroxyphenyl)diphenylmethane, 1,1-bis(4-hydroxyphenyl)-1-phenylethane, 1,1-bis(4-hydroxyphenyl)-1-(1-naphthyl)ethane, 1,1-bis(4-hydroxyphenyl)-1-(2-naphthyl)ethane, 2,2-bis(4-hydroxyphenyl)propane, 2,2-bis(3-methyl-4-hydroxyphenyl)propane, 2,2-bis(3,5-dimethyl-4-hydroxyphenyl)propane, 2,2-bis(4-hydroxyphenyl)-1-phenylpropane, 2,2-bis(4-hydroxyphenyl)hexafluoropropane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane, 1,1-bis(3,5-dimethyl-4-hydroxyphenyl)cyclohexane, 1,1-bis(4-hydroxyphenyl)-4-methylcyclohexane, 1,3-bis[2-(4-hydroxyphenyl)-2-propyl]benzene, 1,1′-bis(4-hydroxyphenyl)-3-diisopropylbenzene, 1,1′-bis(4-hydroxyphenyl)-4-diisopropylbenzene, 1,3-bis[2-(3,5-dimethyl-4-hydroxyphenyl)-2-propyl]benzene, bis(4-hydroxyphenyl) ether, bis(4-hydroxyphenyl) sulfide, bis(4-hydroxyphenyl) sulfone, bis(3,5-dimethyl-4-hydroxyphenyl) sulfone and 2,2′,3,3′-tetrahydro-3,3,3′,3′-tetramethyl-

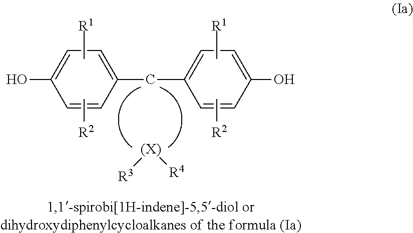

in which
R¹ and R² are independently hydrogen, halogen, preferably chlorine or bromine, C₁-C₈-alkyl, C₅-C₆-cycloalkyl, C₆-C₁₀-aryl, preferably phenyl, and C₇-C₁₂-aralkyl, preferably phenyl-C₁-C₄-alkyl, especially benzyl,
m is an integer from 4 to 7, preferably 4 or 5,
R³ and R⁴ can be chosen individually for each X and are independently hydrogen or C₁-C₆-alkyl and
X is carbon,
with the proviso that, on at least one X atom, R³ and R⁴ are both alkyl. Preferably, in the formula (Ia), on one or two X atom(s), especially only on one X atom, R³ and R⁴ are both alkyl.

A preferred alkyl radical for the R³ and R⁴ radicals in formula (Ia) is methyl. The X atoms in alpha position to the diphenyl-substituted carbon atom (C-1) are preferably non-dialkyl-substituted; by contrast, preference is given to alkyl disubstitution in beta position to C-1.

Particularly preferred dihydroxydiphenylcycloalkanes of the formula (Ia) are those having 5 and 6 ring carbon atoms X in the cycloaliphatic radical (m=4 or 5 in formula (Ia)), for example the diphenols of the formulae (Ia-1) to (Ia-3),

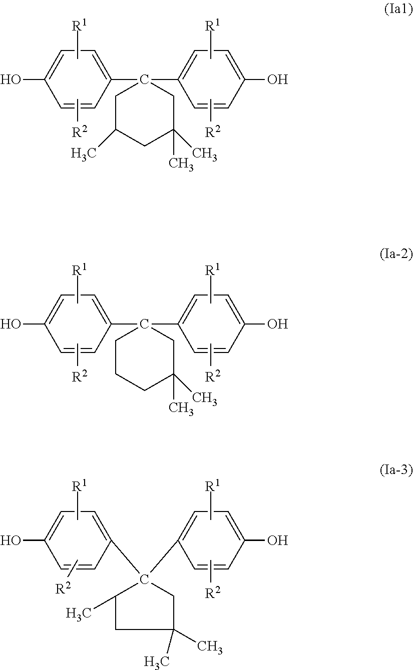

A very particularly preferred dihydroxydiphenylcycloalkane of the formula (Ia) is 1,1-bis(4-hydroxyphenyl)-3,3,5-trimethylcyclohexane (formula (Ia-1) with R¹ and R²=H).

Polycarbonates of this kind can be prepared according to EP-A 359 953 from dihydroxydiphenylcycloalkanes of the formula (Ia).

Particularly preferred dihydroxyaryl compounds are resorcinol, 4,4′-dihydroxydiphenyl, bis(4-hydroxyphenyl)diphenylmethane, 1,1-bis(4-hydroxyphenyl)-1-phenylethane, bis(4-hydroxyphenyl)-1-(1-naphthyl)ethane, bis(4-hydroxyphenyl)-1-(2-naphthyl)ethane, 2,2-bis(4-hydroxyphenyl)propane, 2,2-bis(3,5-dimethyl-4-hydroxyphenyl)propane, 1,1-bis(4-hydroxyphenyl)cyclohexane, 1,1-bis(3,5-dimethyl-4-hydroxyphenyl)cyclohexane, 1,1-bis(4-hydroxyphenyl)-3,3,5-trimethylcyclohexane, 1,1′-bis(4-hydroxyphenyl)-3-diisopropylbenzene and 1,1′-bis(4-hydroxyphenyl)-4-diisopropylbenzene.

Very particularly preferred dihydroxyaryl compounds are 4,4′-dihydroxydiphenyl and 2,2-bis(4-hydroxyphenyl)propane.

It is possible to use either one dihydroxyaryl compound to form homopolycarbonates or various dihydroxyaryl compounds to form copolycarbonates. It is possible to use either one dihydroxyaryl compound of the formula (I) or (Ia) to form homopolycarbonates or multiple dihydroxyaryl compounds of the formula (I) and/or (Ia) to form copolycarbonates. The various dihydroxyaryl compounds may be joined to one another either randomly or in blocks. In the case of copolycarbonates formed from dihydroxyaryl compounds of the formula (I) and (Ia), the molar ratio of dihydroxyaryl compounds of the formula (Ia) to any other dihydroxyaryl compounds of the formula (I) to be used as well is preferably between 99 mol % of (Ia) to 1 mol % of (I) and 2 mol % of (Ia) to 98 mol % of (I), preferably between 99 mol % of (Ia) to 1 mol % of (I) and 10 mol % (Ia) to 90 mol % of (I), and especially between 99 mol % of (Ia) to 1 mol % of (I) and 30 mol % of (Ia) to 70 mol % of (I).

A very particularly preferred copolycarbonate can be prepared using 1,1-bis(4-hydroxyphenyl)-3,3,5-trimethylcyclohexane and 2,2-bis(4-hydroxyphenyl)propane dihydroxyaryl compounds of the formulae (Ia) and (1).

Suitable carbonic acid derivatives may, for example, be diaryl carbonates of the general formula (II),

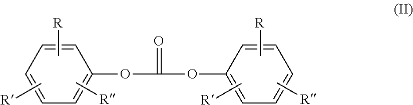

in which
R, R′ and R″ are independently the same or different and are hydrogen, linear or branched C₁-C₃₄-alkyl, C₇-C₃₄-alkylaryl or C₆-C₃₄-aryl, R may additionally also be —COO—R′″ where R′″ is hydrogen, linear or branched C₁-C₃₄-alkyl, C₇-C₃₄-alkylaryl or C₆-C₃₄-aryl.

Preferred diaryl carbonates are, for example, diphenyl carbonate, methylphenyl phenyl carbonates and di(methylphenyl) carbonates, 4-ethylphenyl phenyl carbonate, di(4-ethylphenyl) carbonate, 4-n-propylphenyl phenyl carbonate, di(4-n-propylphenyl) carbonate, 4-isopropylphenyl phenyl carbonate, di(4-isopropylphenyl) carbonate, 4-n-butylphenyl phenyl carbonate, di(4-n-butylphenyl) carbonate, 4-isobutylphenyl phenyl carbonate, di(4-isobutylphenyl) carbonate, 4-tert-butylphenyl phenyl carbonate, di(4-tert-butylphenyl) carbonate, 4-n-pentylphenyl phenyl carbonate, di(4-n-pentylphenyl) carbonate, 4-n-hexylphenyl phenyl carbonate, di(4-n-hexylphenyl) carbonate, 4-isooctylphenyl phenyl carbonate, di(4-isooctylphenyl) carbonate, 4-n-nonylphenyl phenyl carbonate, di(4-n-nonylphenyl) carbonate, 4-cyclohexylphenyl phenyl carbonate, di(4-cyclohexylphenyl) carbonate, 4-(1-methyl-1-phenylethyl)phenyl phenyl carbonate, di[4-(1-methyl-1-phenylethyl)phenyl]carbonate, biphenyl-4-yl phenyl carbonate, di(biphenyl-4-yl) carbonate, 4-(1-naphthyl)phenyl phenyl carbonate, 4-(2-naphthyl)phenyl phenyl carbonate, di[4-(1-naphthyl)phenyl]carbonate, di[4-(2-naphthyl)phenyl]carbonate, 4-phenoxyphenyl phenyl carbonate, di(4-phenoxyphenyl) carbonate, 3-pentadecylphenyl phenyl carbonate, di(3-pentadecylphenyl) carbonate, 4-tritylphenyl phenyl carbonate, di(4-tritylphenyl) carbonate, (methyl salicylate) phenyl carbonate, di(methyl salicylate) carbonate, (ethyl salicylate) phenyl carbonate, di(ethyl salicylate) carbonate, (n-propyl salicylate) phenyl carbonate, di(n-propyl salicylate) carbonate, (isopropyl salicylate) phenyl carbonate, di(isopropyl salicylate) carbonate, (n-butyl salicylate) phenyl carbonate, di(n-butyl salicylate) carbonate, (isobutyl salicylate) phenyl carbonate, di(isobutyl salicylate) carbonate, (tert-butyl salicylate) phenyl carbonate, di(tert-butyl salicylate) carbonate, di(phenyl salicylate) carbonate and di(benzyl salicylate) carbonate.

Particularly preferred diaryl compounds are diphenyl carbonate, 4-tert-butylphenyl phenyl carbonate, di(4-tert-butylphenyl) carbonate, biphenyl-4-yl phenyl carbonate, di(biphenyl-4-yl) carbonate, 4-(1-methyl-1-phenylethyl)phenyl phenyl carbonate, di[4-(1-methyl-1-phenylethyl)phenyl]carbonate and di(methyl salicylate) carbonate. Very particular preference is given to diphenyl carbonate.

It is possible to use either one diaryl carbonate or various diaryl carbonates.

For control or variation of the end groups, it is additionally possible to use, for example, one or more monohydroxyaryl compound(s) as chain terminators that were not used for preparation of the diaryl carbonate(s) used. These may be those of the general formula (III),

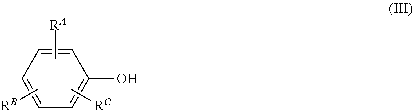

wherein
R^{A} is linear or branched C₁-C₃₄-alkyl, C₁-C₃₄-alkylaryl, C₆-C₃₄-aryl or —COO—R^{D} where R^{D} is hydrogen, linear or branched C₁-C₃₄-alkyl, C₇-C₃₄-alkylaryl or C₆-C₃₄-aryl, and

R^{B}, R^{C} are independently the same or different and are hydrogen, linear or branched C₁-C₃₄-alkyl, C₇-C₃₄-alkylaryl or C₆-C₃₄-aryl.

Such monohydroxyaryl compounds are, for example, 1-, 2- or 3-methylphenol, 2,4-dimethylphenol 4-ethylphenol, 4-n-propylphenol, 4-isopropylphenol, 4-n-butylphenol, 4-isobutylphenol, 4-tert-butylphenol, 4-n-pentylphenol, 4-n-hexylphenol, 4-isooctylphenol, 4-n-nonylphenol, 3-pentadecylphenol, 4-cyclohexylphenol, 4-(1-methyl-1-phenylethyl)phenol, 4-phenylphenol, 4-phenoxyphenol, 4-(1-naphthyl)phenol, 4-(2-naphthyl)phenol, 4-tritylphenol, methyl salicylate, ethyl salicylate, n-propyl salicylate, isopropyl salicylate, n-butyl salicylate, isobutyl salicylate, tert-butyl salicylate, phenyl salicylate and benzyl salicylate.

Preference is given to 4-tert-butylphenol, 4-isooctylphenol and 3-pentadecylphenol.

Suitable branching agents may compounds having three or more functional groups, preferably those having three or more hydroxyl groups.

Suitable compounds having three or more phenolic hydroxyl groups are, for example, phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis(4,4-bis(4-hydroxyphenyl)cyclohexyl)propane, 2,4-bis(4-hydroxyphenylisopropyl)phenol and tetra(4-hydroxyphenyl)methane.

Other suitable compounds having three or more functional groups are, for example, 2,4-dihydroxybenzoic acid, trimesic acid/trimesoyl chloride, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

The coating material composition of the coating of the inventive film contains
a) urethane (meth)acrylate which has (meth)acryloyl groups and an isocyanate functionality of ≥1.75 to ≤2.3, preferably of ≥1.85 to ≤2.2, very particularly preferably of ≥1.9 to ≤2.1,
b) acrylated acrylate which still has free isocyanate-reactive groups,
c) optionally additives and/or solvents.

The urethane (meth)acrylates a) which have (meth)acryloyl groups and an isocyanate functionality (NCO functionality) of ≥1.75 to ≤2.3, preferably of ≥1.85 to ≤2.2, very particularly preferably of ≥1.9 to ≤2.1, are preferably obtainable by reaction of
a-1) a monohydric alcohol having (meth)acryloyl groups and
a-2) polyisocyanates having an isocyanate functionality in the range from ≥2.5 to ≤6.0, preferably from ≥2.7 to ≤4.5, particularly preferably from ≥2.8 to ≤3.5.

Processes for preparing urethane (meth)acrylates are known in principle and described, for example, in DE-A 1 644 798, DE-A 2 115 373 or DE-A 2 737 406. For the preparation of the inventive urethane (meth)acrylates having free isocyanate groups, the ratio of NCO groups to OH groups is 1:0.2 to 1:0.8, preferably from 1:0.3 to 1:0.6. The urethane (meth)acrylates a) used in accordance with the invention have, in addition to the meth(acryloyl) groups, an NCO functionality of ≥1.75 to ≤2.3, preferably of ≥1.85 to ≤2.2, very particularly preferably of ≥1.9 to ≤2.1.

“Monohydric alcohols having (meth)acryloyl groups” are to be understood as meaning not only free hydroxyl group-containing esters of (meth)acrylic acid with dihydric alcohols such as, for example, 2-hydroxyethyl, 2- or 3-hydroxypropyl or 2-, 3- or 4-hydroxybutyl (meth)acrylate, but also any desired mixtures of such compounds. Also useful are monohydric alcohols having (meth)acryloyl groups or reaction products consisting substantially of such alcohols, obtained by esterification of n-hydric alcohols with (meth)acrylic acid, wherein alcohols that may be used also include mixtures of different alcohols, so that n represents an integer or an, on average, fractional number of greater than 2 to 4, preferably 3, and wherein, per mole of the alcohols mentioned, from (n-0.8) to (n-1.2), preferably (n-1) mol of (meth)acrylic acid are employed. These compounds/product mixtures include, for example, the reaction products of i) glycerol, trimethylolpropane and/or pentaerythritol, of low molecular weight alkoxylation products of such alcohols, for example ethoxylated or propoxylated trimethylolpropane, for example the addition product of ethylene oxide onto trimethylolpropane having an OH number of 550 or of any desired mixtures of such at least trihydric alcohols with dihydric alcohols such as, for example, ethylene glycol or propylene glycol, with (ii) (meth)acrylic acid in the molar ratio given.

These compounds have a molecular weight of 116 to 1000, preferably of 116 to 750 and particularly preferably of 116 to 158.

Suitable polyisocyanates are in principle aromatic, araliphatic and aliphatic, with aliphatic compounds being preferred, for example butylene diisocyanate, hexamethylene diisocyanate (HDI), isophorone diisocyanate (IPDI), 2,2,4-trimethylhexamethylene diisocyanate and/or 2,4,4-trimethylhexamethylene diisocyanate, neopentyl diisocyanate, dicyclohexylmethane diisocyanate or 4-isocyanatomethyloctane 1,8-diisocyanate or derivatives thereof with urethane, isocyanurate, allophanate, biuret, uretdione, iminooxadiazinedione structure and mixtures thereof. Polyisocyanates having urethane groups and based on polyisocyanates and dihydric alcohols are also suitable. These polyisocyanates have an NCO functionality in the range from ≥2.5 to ≤6.0, preferably from ≥2.7 to ≤4.5, particularly preferably from ≥2.8 to ≤3.5.

The addition reaction of components a-1) and a-2) can be sped up in a manner known per se by means of suitable catalysts, for example zinc octoate, dibutyltin dilaurate or tertiary amines.

In one preferred variant, an oxygen-containing gas, preferably air, is passed through the reaction mixture during the preparation, in order to prevent undesired polymerization of the (meth)acrylates.

Acrylated acrylates b), which still have free isocyanate-reactive groups, preferably have hydroxyl groups as isocyanate-reactive groups. Preferably, the acrylated acrylates b) that are to be used in accordance with the invention are dissolved in solvent, preferably in butyl acetate, particularly preferably a 45% solution of butyl acetate. The acrylated acrylates b) advantageously have a viscosity in solution of 2600 to 3400 mPa*s at 23° C., preferably of 2800 to 3200 mPa*s at 23° C. One example of a commercially available acrylated acrylate is EBECRYL™ 1200 from Allnex Belgium SA/NV.

Additives and/or solvents typically used in coating material, paint and printing ink technology may optionally be present in the coating material composition. Examples of these are described hereafter.

By way of example, photoinitiators may be added to the coating material composition. Photoinitiators are initiators that are activatable by actinic radiation and trigger a free-radical polymerization of the relevant polymerizable groups. Photoinitiators are compounds that are known per se and are sold commercially, with a distinction being made between unimolecular (type I) and bimolecular (type II) initiators. Examples of (type I) systems are aromatic ketone compounds, for example benzophenones in combination with tertiary amines, alkylbenzophenones, 4,4′-bis(dimethylamino)benzophenone (Michler's ketone), anthrone and halogenated benzophenones or mixtures of the types mentioned. Also suitable are (type II) initiators such as benzoin and derivatives thereof, benzil ketals, acylphosphine oxides, for example 2,4,6-trimethylbenzoyldiphenylphosphine oxide, bisacylphosphine oxides, phenylglyoxylic esters, camphorquinone, α-aminoalkylphenones, α,α-dialkoxyacetophenones and α-hydroxyalkylphenones. It may be advantageous also to use mixtures of these compounds. Suitable initiators are commercially available, for example under the names Irgacure™, Darocur™ and Esacure™ (IGM Resins BV).

In particular, these are stabilizers, light stabilizers such as UV absorbers and sterically hindered amines (HALS), additionally antioxidants and also coating auxiliaries, for example antisettling agents, defoaming and/or wetting agents, flow control agents, plasticizers, antistats, catalysts, auxiliary solvents and/or thickeners and also pigments, dyes and/or matting agents.

Suitable solvents are matched to the binders used and also to the application method. Examples are ethyl acetate, butyl acetate, methoxypropyl acetate, diacetone alcohol, glycols, glycol ethers, xylene or solvent naphtha from Exxon-Chemie as aromatic solvent, and also mixtures of the solvents mentioned.

The additives optionally present in the coating material composition can be used in an amount of 0% to ≤5% by weight, preferably 0.1% to ≤3.5% by weight, based on solids content of the coating material composition. Solvents can typically be used in an amount of 0% to 75% by weight, preferably of 0% to 60% by weight.

Components a) and b) of the coating material composition are preferably used in a ratio of equivalents of 0.5:1.0 to 1.1:1.0, preferably 0.6:1 to 1.0:1.0, particularly preferably of 0.7:1 to 0.95:1 in the coating material composition.

After application of the coating, the inventive coated film can be thermally cured at a temperature of ≥50° C., preferably ≥80° C. to ≤130° C., particularly preferably ≥100° C. to ≤120° C. The inventive film can then be stored and/or immediately processed further. The final curing using actinic radiation is ideally effected only after complete further processing to give the desired end product, preferably to give a layer composite, particularly preferably to give a security document and/or valuable document.

The coating of the inventive film, after thermal curing, preferably has a thickness of in the range of ≥2 to ≤20 μm, preferably of ≥3 to ≤15 μm, particularly preferably of ≥5 to ≤11 μm.

The overall thickness of the inventive film may ideally be ≥10 to ≤150 μm, preferably ≥20 to ≤130 μm, particularly preferably ≥25 to ≤100 μm.

The invention further provides a method for producing the film described above. This method comprises the steps of
i) providing a thermoplastic film,
ii) coating the thermoplastic film with a coating material composition containing
   a) urethane (meth)acrylate which has (meth)acryloyl groups and an isocyanate functionality of ≥1.75 to ≤2.2, preferably of ≥1.85 to ≤2.3, very particularly preferably of ≥1.9 to ≤2.1,
   b) acrylated acrylate which still has free isocyanate-reactive groups,
   c) optionally additives and/or solvents,
iii) thermally curing the coated film.

After method step iii), the inventive film can be stored and/or immediately processed further.

To avoid repetition, reference is made to the statements above regarding the description and advantageous embodiments of the thermoplastic film and of the coating material composition.

The thermoplastic film is preferably a single-layer thermoplastic film.

The coating material composition is applied in step ii) to the thermoplastic film by the methods known to those skilled in the art, such as for example by means of roller coating, knife-coating, flow-coating, spraying or casting. Printing methods, dipping, transfer methods and painting are likewise possible. The application should be effected with the exclusion of radiation, since this may otherwise lead to premature polymerization of the (meth)acryloyl double bonds of the coating material composition.

The thermal curing of the coating material composition in step iii) ideally immediately follows the coating of the film with the inventive coating material composition. This procedure is done especially at elevated temperatures in ovens and with moving and optionally also dehumidified air (convection ovens, nozzle dryers) and also thermal radiation (IR, NIR). In addition, it is possible to use microwaves. It is possible and advantageous to combine a plurality of these drying processes.

Advantageously, the conditions for the thermal curing are selected such that the elevated temperature and/or the thermal radiation does not trigger any polymerization (crosslinking) of the (meth)acryloyl groups. In addition, the maximum temperature attained should appropriately be selected at a sufficiently low level for the film not to deform in an uncontrolled manner. The thermal curing can at temperatures of ≥50° C., preferably ≥80° C. to ≤130° C., particularly preferably ≥100° C. to ≤120° C.

After the thermal curing step iii), the coated film, optionally after lamination with a protective film on the coating, can be rolled up. The film can be rolled up without the coating sticking to the reverse side of the substrate film or of the lamination film. However, it is also possible to cut the coated film to size and to send the cut sections individually or as a stack to further processing.

In one advantageous embodiment, at least one inventive film is present in a layer construction, preferably in a security document and/or valuable document, particularly preferably in an identification document. Such layer constructions, preferably security documents and/or valuable documents, particularly preferably identification documents, can be produced by the methods known to those skilled in the art, for example by lamination of a stack comprising a plurality of thermoplastic films, wherein this layer construction, preferably security document and/or valuable document, particularly preferably identification document, comprises at least one inventive film, and wherein the coated side of the inventive film is directed toward the outside. With particular preference, the layer composite comprises, preferably in a security document and/or valuable document, very particularly preferably in an identification document, at least two inventive films, wherein the coated sides of the inventive films are in each case directed toward the outside.

Especially for the production of security documents and/or valuable documents, it may be necessary to apply, for example, security-relevant information in the form of embossing to the upper layer. This embossing can be effected with structures on the micrometer scale and is known by the names multiple laser image (MLI) and changeable laser image (CLI). This embossing can be effected during or after the production of the inventive layer construction, preferably security document and/or valuable document, particularly preferably identification document, in at least one outer layer of the inventive layer construction.

Within the context of the invention, the term “information” encompasses any information that is reproducible in any form whatsoever—and, in the case of embossed information, that is also embossable. This information may by way of example be individual numbers, combinations of numbers, individual letters, combinations of letters, words, inscriptions, symbols, repeating patterns, line structures, decorations, images or other depictions, and also combinations of these.

The final curing by means of actinic radiation, preferably by means of UV radiation, is effected in a final method step, preferably not until after production of the desired end product, particularly preferably after production of a layer composite by lamination, wherein the layer composite comprises the inventive film on at least one outer side of the layer composite, preferably on both outer sides of the layer composite.

The inventive method can therefore optionally be supplemented after steps i) to iii) by the following method steps:
iv) producing a layer construction, preferably a security document and/or valuable document, particularly preferably identification document, comprising a plurality of thermoplastic films, wherein the layer construction, preferably security document and/or valuable document, particularly preferably identification document, comprises at least one inventive film and wherein the coated side of the inventive film is directed toward the outside,
v) optionally applying embossing, preferably embossing on the micrometer scale, to at least one outer side of the layer construction during or after step iv),
vi) effecting final curing of the layer construction, preferably security document and/or valuable document, particularly preferably identification document, by means of actinic radiation, preferably by means of UV radiation.

In a further embodiment of the inventive method, in step iv) the layer construction, preferably the security document and/or valuable document, particularly preferably the identification document, can be produced by lamination. In one particularly preferred embodiment, the plates for the lamination have a coating, preferably a dirt-repellent coating.

Curing with actinic radiation is understood to mean the free-radical polymerization of ethylenically unsaturated carbon-carbon double bonds by means of initiator radicals which are released, for example, from the above-described photoinitiators through irradiation with actinic radiation.

The radiation curing is preferably effected by the action of high-energy radiation, i.e. UV radiation or daylight, for example light of wavelength ≥200 nm to ≤750 nm, or by irradiation with high-energy electrons (electron beams, for example ≥90 keV to ≤300 keV). The radiation sources used for light or UV light are, for example, moderate- or high-pressure mercury vapor lamps, wherein the mercury vapor may be modified by doping with other elements such as gallium or iron. Lasers, pulsed lamps (known by the name UV flashlight emitters), halogen lamps or excimer emitters are likewise usable. The emitters may be installed at a fixed location, such that the material to be irradiated is moved past the radiation source by means of a mechanical device, or the emitters may be mobile, and the material to be irradiated does not change position in the course of curing. The radiation dose typically sufficient for crosslinking in the case of UV curing is in the range from ≥80 mJ/cm² to ≤5000 mJ/cm².

The irradiation can optionally also be performed with exclusion of oxygen, for example under inert gas atmosphere or reduced-oxygen atmosphere. Suitable inert gases are preferably nitrogen, carbon dioxide, noble gases or combustion gases. In addition, the irradiation can be effected by covering the coating with media transparent to the radiation. Examples thereof are by way of example plastics films, glass or liquids such as water.

In addition, depending on the film used, it may be advantageous to select the irradiation conditions such that the thermal stress does not become too great. In particular, thin films and films made from materials having a low glass transition temperature can have a tendency to uncontrolled deformation when a particular temperature is exceeded as a result of the irradiation. In these cases, it is advantageous to allow as little infrared radiation as possible to act on the substrate, by means of suitable filters or a suitable design of the emitters. In addition, reduction of the corresponding radiation dose can counteract uncontrolled deformation. However, it should be noted that a particular dose and intensity of the irradiation are needed for maximum polymerization. It is particularly advantageous in these cases to conduct curing under inert or reduced-oxygen conditions, since the required dose for curing decreases when the oxygen content is reduced in the atmosphere above the coating.

Particular preference is given to using mercury emitters in fixed installations for curing. For the curing of these coatings, preference is given to using a dose of ≥80 mJ/cm² to ≤5000 mJ/cm², preferably ≥200 mJ/cm² to ≤4000 mJ/cm², particularly preferably ≥1000 mJ/cm² to ≤3000 mJ/cm².

It is also possible that the inventive film optionally has a layer of adhesive on the side not coated with the coating. Suitable adhesive coatings are for example those based on polyurethane or acrylate adhesives. Adhesives of this kind are known to those skilled in the art.

If the inventive film optionally has a layer of adhesive on the side not coated with the coating, the use of a latent-reactive adhesive is preferred. Latent-reactive adhesives are known to those skilled in the art. Preferred latent-reactive adhesives are those which have an aqueous dispersion containing a di- or polyisocyanate having a melting/softening temperature of >30° C. and an isocyanate-reactive polymer. Such an aqueous dispersion preferably has a viscosity of at least 2000 mPas. The isocyanate-reactive polymer in this dispersion is further preferably a polyurethane that is constructed from crystallizing polymer chains which when measured by means of thermomechanical analysis (TMA) partially or fully decrystallize at temperatures below +110° C., preferably at temperatures below +90° C. The TMA measurement is conducted analogously to ISO 11359 Part 3 “Determination of penetration temperature”. The di- or polyisocyanate is further preferably one selected from the group of dimerization products, trimerization products and urea derivatives of TDI (tolylene diisocyanate) or IPDI (isophorone diisocyanate). Such latent-reactive adhesives have been described, for example, in DE-A 10 2007 054 046. The use of such latent-reactive adhesives can bring about an additional increase in forgery protection of the security document and/or valuable document by virtue of the fact that water vapor and/or air can no longer diffuse into the interior via the edges of the layer construction and thus can no longer lead to subsequent delamination. Such layer constructions can no longer be separated without being destroyed.

The invention also further provides a layer construction comprising at least one inventive film, wherein the coated side of the inventive film is directed toward the outside. In one particularly preferred embodiment of the invention, the layer composite comprises than at least two inventive films, wherein the coated side of the inventive film is in each case directed toward the outside. The inventive layer construction preferably additionally comprises a plurality of thermoplastic films.

The inventive films offer the advantage that layer composites produced therefrom withstand the high lamination temperatures in the production of security documents and/or valuable documents, preferably identification documents, without sticking to the mold or being destroyed or impaired in terms of their properties at the same time. Customary lamination conditions for such security documents and/or valuable documents, preferably I identification documents, are by way of example lamination temperatures of 100 to 200° C., preferably of 120 to 190° C., and laminating pressures of up to 380 N/cm², preferably between 200 and 350 N/cm², during the lamination. Preferably, plates which have a coating, preferably a dirt-repellent coating, are used for the lamination. The inventive layer composites a high resistance to chemicals and a high stability and bending strength even under extreme stresses, such as for example heat. In addition, the possible application of embossing into the outer layer is not impaired by cracks in the surface.

Further data and/or information, preferably personalized data and/or information, may be applied by means of laser engraving to the inventive layer composite and/or to one of the thermoplastic films of the inventive layer composite prior to, during, or after step vi).

The inventive layer construction is preferably suitable for increasing forgery protection of security documents, particularly preferably identification documents. The inventive layer construction is very particularly preferably suitable for increasing forgery protection of those identification documents that are in the form of bonded or laminated layer composites in the form of plastics cards, such as for example personal identification cards, passports, driver's licenses, credit cards, bank cards, cards for access control or other identity documents etc. Preferred identification documents within the context of the present invention are multilayer sheet-format documents having security features such as chips, photographs, biometric data etc. These security features can be visible or at least interrogable from the outside. Such an identification document preferably has a size between that of a check card and that of a passport. Such an identification document can also be part of a document composed of a plurality of parts, such as for example an identification document made of plastic in a passport that also comprises paper or paperboard parts.

The invention additionally provides for the use of a coating material composition containing

a) urethane (meth)acrylate which has (meth)acryloyl groups and an isocyanate functionality of ≥1.75 to ≤2.3, preferably of ≥1.85 to ≤2.2, very particularly preferably of ≥1.9 to ≤2.1,
b) acrylated acrylate which still has free isocyanate-reactive groups,
c) optionally additives and/or solvents,
for the coating of thermoplastic films.

### EXAMPLES

Makrofol™ ID 6-2-750061: thermoplastic film based on polycarbonate with a thickness of 100 μm from Covestro Deutschland AG
Makrofol™ ID 4-4-010207: white thermoplastic film based on polycarbonate with a thickness of 450 μm from Covestro Deutschland AG
Makrofol™ ID 320: a single-sidedly coated polycarbonate film with a thickness of 105 μm from Covestro Deutschland AG
Makrofol™ 1-4: thermoplastic film based on polycarbonate with a thickness of 100 m from Covestro Deutschland AG. Surface: high-gloss (=1)/fine matt (=4).
Norilux™ DC-4: abrasion-resistant, deformable dual cure coating material from Pröll KG, Germany
Norilux™ Hardener 036: hardener for mixing with Norilux™ DC-4 from Pröll KG, Germany

### Preparation of the Isocyanate Group-Containing Urethane (Meth)Acrylate

The isocyanate group-containing urethane (meth)acrylate was prepared in accordance with EP-A 1103572 “Isocyanate group-containing urethane (meth)acrylate B”:

An apparatus with stirrer, gas inlet and thermometer is initially charged with 552 g of Desmodur™ N 3600 (commercial product from Covestro Deutschland AG, Leverkusen; a polyisocyanate containing essentially HDI isocyanurates, NCO content: 23.4% by weight, viscosity 1200 mPa*s at 23° C.) while passing air through (single flask volume per hour) and passing nitrogen over (double flask volume per hour). 1.6 g of 2,6-di-tert-butyl-4-methylphenol are added thereto. The solution is heated to 60° C. while stirring. The heat source is removed and 116.0 g of 2-hydroxyethyl acrylate are added dropwise thereto such that the temperature is between 55 and 65° C. Subsequently, reaction is continued at 60° C. until the NCO content is below 12.5% by weight. The resulting product has a dynamic viscosity of 12 Pa*s at 23° C.

### Preparation of the Coating Material Composition of the Coating Composition

### Component a)

20.9 kg of the isocyanate group-containing urethane (meth)acrylate prepared above are initially charged and mixed with 22.0 kg of diacetone alcohol.

### Component b)

18.5 kg of Ebecryl™ 1200 (Allnex S.a.r.l.) are initially charged and mixed with 730 g of Byk™ 306 (20% in i-methoxy-2-propanol), 870 g of dibutyltin dilaurate (1% in butyl acetate). 1.71 kg of Irgacure™ 184 (50% in 1-methoxy-2-propanol) and 35.29 kg of a 1:1 mixture of diacetone alcohol and 1-methoxy-2-propanol.
Production of Film 1 Coated in Accordance with the Invention

The coating solution is applied to a film (Makrofol™ ID 1-4 of thickness 75 μm) by means of a slot coater in a roll-to-roll coating system, to the rough side of the film. Components a) and b) of the coating composition are mixed with one another by means of a static mixer immediately before introduction into the slot coater. The speed of the film was 0.7 m/min.

The layer thickness of the coating composition was 25-30 μm wet and 10-12 μm after thermal curing. The thermal curing was effected at 110° C. for 10 min in a circulating air dryer.

The thus-produced film had a thickness of 80 μm.

The thus-produced, coated film was able to be rolled up tack-free without lamination film, and so it had a high blocking resistance.

### Production of a Coated Film 2 (Comparative):

A coated film 2 was produced according to WO-A 2012/019583, example 4, as follows: Norilux™ DC-4 was mixed with Norilux™ Hardener 036 in the ratio 10:1 and homogenized by stirring. This coating material mixture was applied to a 100 μm thick Makrofol™ ID1-4 film by the screen printing method using a screen with a screen density of 70 threads/inch under artificial light containing no UV rays. After applying the coating material layer, the solvents were evaporated in a jet dryer at a temperature of 110° C. for approximately 10 minutes.

The resulting coated film had a high blocking resistance.

### Production of a Coated Film 3 (Comparative)

In a 15 l tank, Degalan™ M920 (copolymer based on PMMA, M, =300 000; from Evonik) was dissolved in 1-methoxy-2-propanol at 100° C. (internal temperature) as follows: 4500 g of 1-methoxy-2-propanol were initially charged and 1100 g of Degalan™ M920 were introduced while stirring. They were rinsed in with 2500 g of 1-methoxy-2-propanol. The dissolving operation took about 4 hours. In this way, a homogeneous, clear, colorless and viscous composition was obtained. After the dissolving operation, the mixture was cooled to room temperature. 1100 g of dipentaerythritol penta-/hexaacrylate (DPHA from Cytec) were diluted separately with 2500 g of I-methoxy-2-propanol. At room temperature, this solution was added to the apparatus and mixed in for 2 hours. 44.0 g of Irgacure™ 1000 (IGM Resins BV), 22.0 g of Darocure™ 4265 (IGM Resins BV) and 5.5 g of BYK™ 333 (BYK) were separately diluted with 400 g of 1-methoxy-2-propanol. On attainment of homogeneity of this solution, it was added to the apparatus and mixed in thoroughly. The mixture was subsequently stirred with exclusion of light for about 6 hours. Yield: 11 363 g. The coating composition had a solids content of 17% and a viscosity (23° C.) of 9000 mPas. In the solids content of the coating composition, the proportion of the high polymer, and likewise the proportion of the reactive diluent, were each 48.4% by weight.

This coating was applied to a 100 μm thick Makrofol™ ID1-4 film with a dry layer thickness of 10-12 μm.

### Production of a Coated Film 4 (Comparative)

The coating of the commercial product Makrofol™ HF329 (an extruded polycarbonate film that is high-gloss on both sides and is provided on one side with a UV-curable coating system, obtainable with a standard thickness of 280 m) was applied to a 100 m thick Makrofol™ ID1-4 film with a dry layer thickness of 10-12 μm.

### Production of a Layer Composite in the Form of a Card

### Example 1: Production of a Card Using Film 1 Coated in Accordance With the Invention DIN A4 Films Were Placed Together in Accordance With Diagram

Diagram 1:

| | |
|---|---|
| [symbol] | film 1 with a thickness of 80 μm with the coated side |
| | lying on the outside |
| [symbol] | 100 μm Makrofol ™ ID 6-2 - 750061 |
| [symbol] | 450 μm Makrofol ™ ID4-4 - 010207 |
| [symbol] | 100 μm Makrofol ™ ID6-2 - 750061 |
| [symbol] | film 1 with a thickness of 80 μm with the coated side |
| | lying on the outside |

The film stack as per diagram 1 was placed between two highly polished 500 μm thick steel plates from 4 Plate GmbH (Wuppertal, Germany). These steel plates are after-treated plates having a dirt-repellent coating (4 Slide type). The plates contain an engraving for the embossing.

This construction was placed in a heated laminating press from Bürckle (model 50/100) and laminated under the following lamination conditions:

Temperature of the heating press: 190° C.
Specific surface pressure in the heating press: 25 N/cm²
Residence time in the heating press: 8 minutes
Initiation of the cooling phase, specific surface pressure 150 N/cm²
Residence time in the cooling press until 38° C. was reached

Cards corresponding to the check card size (ID 1 format according to ISO/IEC 7810) were punched from the thus-obtained product.

The card was irradiated from both sides with a UV lamp (mercury lamp from the manufacturer Fusion UV Systems) with a dose of 2.5 J/cm². The UV energy was measured by means of a radiometer from International Light Technologies, model ILT490.

### Example 2 (Comparative)

A card was produced as described in example 1. However, Makrofol™ ID 320 was used instead of film 1. The card was not subjected to UV curing though, since the Makrofol™ ID 320 film has already undergone final curing.

### Example 3 (Comparative)

A card was produced as described in example 1. However, instead of film 1, film 2 according to diagram 2 was used, the other conditions for production of the card corresponding to those as were described in example 1:

Diagram 2:

| | |
|---|---|
| [symbol] | 100 μm film 2, coated side toward the outside |
| [symbol] | 100 μm Makrofol ™ ID6-2---750061 |
| [symbol] | 450 μm Makrofol ™ ID4-4--010207 |
| [symbol] | 100 μm Makrofol ™ ID6-2---750061 |
| [symbol] | 100 μm film 2 with the coated side toward the outside. |

### Example 4 (Comparative)

A card was produced as described in example 1. However, film 3 was used instead of film 1.

### Example 5 (Comparative)

A card was produced as described in example 1. However, film 4 was used instead of film 1.

TABLE 1
Characterization of the cards from examples 1 to 5:

| Property | Ex. 1 | Ex. 2(C) | Ex. 3(C) | Ex. 4(C) | Ex. 5(C) |
|---|---|---|---|---|---|
| Blocking | 0 | 0 | 0 | 0 | 0 |
| resistance | | | | | |
| Embossing | no cracks | cracks | no | no cracks | cracks |
| of CLI/MLI | | | cracks | | |
| Layflat | 0 cm | only from | 0 cm | 0 cm | 0 cm |
| | | 100 μm | | | |
| | | thickness | | | |
| | | <1 cm | | | |
| Solvent | 0/0/0/1/2 | 0/0/0/0/0 | 1/4/3/5/5 | 0/0/0/0/1 | 0/0/0/0/0 |
| resistance | | | | | |
| Bending test | >90 000 | >90 000 | >80 000 | 8000 | 7000 |
| Bending test | 30 000 | 5000 | >25 000 | 5000 | 5000 |
| after climate | | | | | |
| treatment | | | | | |

Ex.: example;
(C): comparative

Description of the determination of the properties given in table 1:

Blocking Resistance:

Conventional test methods as described, for instance, in DIN 53150 are insufficient to simulate the blocking resistance of rolled-up, pre-dried coating films, and therefore the following test was employed. The coating materials were applied to Makrofol™ DE 1-1 films (375 μm) with a commercial coating bar (target wet layer thickness 100 μm). After a flash-off phase at 20° C. to 25° C. of 10 min, the coated films were dried in an air circulation oven at 110° C. for 10 min. After a cooling phase of 1 min, a commercial GH-XI73 nature pressure-sensitive lamination film (from Bischof und Klein, Lengerich, Germany) was applied without creasing to the dried coating film with a plastic ink roller over an area of 100 mm×100 mm. Subsequently, the laminated film piece was subjected to a weight of 10 kg over the full area for 1 hour. Thereafter, the lamination film was removed and the coating surface was assessed visually.

Under these conditions, all of the films used on both outer sides in examples 1 to 5 are resistant to blocking, i.e. no additional or anomalous structure forms in the region of the stress.

### CLI/MLI Structures

These are structures which in cross section have dimensions of approximately 80×80 μm², and which have been engraved into the steel plates between which the film stack was inserted for the production of the card in examples 1 to 5. These structures must be transferred into the surface of the card during lamination of the cards, without cracks forming in the hard coat. This was assessed by optical microscopy.

### Layflat

A sheet in the A4 format was placed, with the coated side upward, on a planar support. The extent to which the corners or edges are raised from the surface was measured.

### Solvent Resistance

The solvent resistance of the coatings was tested with isopropanol, xylene, 1-methoxy-2-propyl acetate, ethyl acetate, acetone, in technical-grade quality. The solvents were applied to the coating with a soaked cotton pad and protected from vaporization by covering. Unless described otherwise, a contact time of 60 minutes at about 23° C. was observed. After the end of the contact time, the cotton pad is removed and the test surface is wiped clean with a soft cloth. This is followed by visual inspection immediately and after light scratching with a fingernail.

A distinction is made between the following levels:
0=unchanged; no change visible; not damageable by scratching.
1=slight swelling visible, but not damageable by scratching.
2=change clearly visible, barely damageable by scratching.
3=noticeable change, surface destroyed after firm fingernail pressure.
4=severe change, scratched through to substrate after firm fingernail pressure.
5=destroyed; coating material already destroyed on wiping off the chemical; the test substance is not removable (has eaten into surface).

The values for the 5 solvents are written as an assessment one after another simply in the aforementioned order of the solvents. Values of 0 and 1 generally constitute passing of the test.

### Bending Test

The bending test was conducted according to ISO 10373-1.

A first bending test was effected after production of the card and a further bending test (“Bending test after climate treatment” in table 1) was effected after storage of the card in a climate-controlled chamber for 168 h, at a temperature of 85° C., to assess the bendability of the card even under extreme stress.

### Summary of the Results

The criterion of blocking resistance was satisfied by all outer films used in examples 1 to 5. On embossing of CLI/MLI structures, differences are apparent: while example 2 and example 5 feature exceptional mechanical and chemical resistance, they display cracks in the region of the embossed structures after the lamination. Example 2 is unsuitable with respect to layflat. Solvent resistance in example 3 is unsatisfactory.

Only examples 1, 2 and 3 prove to be sufficiently flexible in the bending test. Examples 4 and 5 do not pass the customary requirement of >80 000 bending operations even before climate-controlled storage. The materials become fatigued too quickly and already crack after <10 000 bending operations. Examples 2, 4 and 5 clearly become more brittle during the climate-controlled storage and no longer pass the bending test after climate-controlled storage. Only the two systems 1 and 3 are capable of passing the bending test in the required manner before and after climate-controlled storage.

The properties discussed (embossability, solvent resistance and bending test with and without climate-controlled storage) as a whole show that the use of film 1 as outer layer in a layer composite (example 1) is very advantageous, compared to the other examples chosen, for the use as protective film in security documents.

1.-15. (canceled)

16. A film comprising a thermoplastic film and a coating, wherein the coating has been produced from a coating material composition containing
a) urethane (meth)acrylate which has (meth)acryloyl groups and an isocyanate functionality of ≥1.75 to ≤2.3,
b) acrylated acrylate which still has free isocyanate-reactive groups,
c) optionally additives and/or solvents.

17. The film as claimed in claim 16, wherein the components a) and b) are used in a ratio of equivalents of 0.5:1.0 to 1.1:1.0.

18. The film as claimed in claim 16, wherein the urethane (meth)acrylate is obtained by reaction of
(a-1) a monohydric alcohol having (meth)acryloyl groups and
(a-2) polyisocyanates having an isocyanate functionality in the range from ≥2.5 to ≤6.0.

19. The film as claimed in claim 16, wherein the acrylated acrylate has hydroxyl groups as isocyanate-reactive groups.

20. The film as claimed in claim 16, wherein the acrylated acrylate has a viscosity in solution in the range from 2600 to 3400 mPa*s at 23° C.

21. The film as claimed in claim 16, wherein the film is subjected to thermal curing at a temperature of ≥50° C.

22. The film as claimed in claim 16, wherein the thermoplastic film comprises one or more polycarbonates or copolycarbonates based on diphenols, poly- or copoly(meth)acrylates, poly- or copolycondensates of terephthalic acid or blends thereof.

23. The film as claimed in claim 16, wherein the coating, after thermal curing, has a thickness in the range of ≥2 to ≤20 μm.

24. A method for producing a film as claimed in claim 16, comprising the steps of:
i) providing a thermoplastic film,
ii) coating the thermoplastic film with a coating material composition containing
a) urethane (meth)acrylate which has (meth)acryloyl groups and an isocyanate functionality of ≥1.75 to ≤2.2,
b) acrylated acrylate which still has free isocyanate-reactive groups,
c) optionally additives and/or solvents,
iii) thermally curing the coated film.

25. The method as claimed in claim 24, further comprising the steps of:
iv) producing a layer construction comprising a plurality of thermoplastic films, wherein the layer construction, comprises at least one film coated film and wherein the coated side of the film is directed toward the outside,
v) optionally applying embossing, preferably embossing on the micrometer scale, to at least one outer side of the layer construction during or after step iv),
vi) effecting final curing of the layer construction by means of actinic radiation.

26. The method as claimed in claim 25, wherein in step iv) the layer construction is produced by lamination.

27. The method as claimed in claim 25, wherein in step iv) the layer construction comprises at least two coated films as claimed in claim 16 and wherein the coated side of the film as claimed in claim 16 is in each case directed toward the outside.

28. The method as claimed in claim 25, wherein prior to, during or after step vi) further information is applied by means of laser engraving.

29. A layer construction comprising at least one film as claimed in claim 16, wherein the coated side of the film as claimed in claim 16 is directed toward the outside.

30. The use of a coating material composition containing
a) urethane (meth)acrylate which has (meth)acryloyl groups and an isocyanate functionality of ≥1.75 to ≤2.3,
b) acrylated acrylate which still has free isocyanate-reactive groups,
c) optionally additives and/or solvents,
for the coating of thermoplastic films.
